(19) United States
(12) Patent Application Publication
(10) Pub. No.: US 2005/0184206 A1
(43) Pub. Date: Aug. 25, 2005

(54) Flexible rod for a banner support assembly

(76) Inventors: Roger M. Lepley, Kalamazoo, MI (US); Jerome A. Sivak, Portage, MI (US)

Correspondence Address: FLYNN THIEL BOUTELL & TANIS, P.C., 2026 RAMBLING ROAD, KALAMAZOO, MI, 49008-1699, US

(21) Appl. No.: 11/061,324

(22) Filed: Feb. 18, 2005

Related U.S. Application Data
(60) Provisional application No. 60/546,316, filed on Feb. 20, 2004.

(51) Int. Cl. F16M 11/24

(52) U.S. Cl. 248/219.4

(57) ABSTRACT

A support rod for use in a banner support assembly which has a solid elongate elastically flexible body of a finite length transitioning lengthwise from a first end having a first cross-sectional area to a second end having a second cross-sectional area less than the aforesaid first cross-sectional area. This support rod is configured to be mounted on a holder fixed to a supporting member for effecting a holding taut of an elongate banner having sleeve-like openings in opposite longitudinal ends thereof.

### CROSS REFERENCE TO RELATED APPLICATIONS

This application claims the benefit of U.S. Provisional Application No. 60/546 316, filed Feb. 20, 2004.

### FIELD OF THE INVENTION

This invention relates to a support rod configured for use in a banner support assembly as well as a banner support assembly adapted to be mounted on a supporting member for purposes of engaging and holding taut an elongate banner having sleeve-like openings in the opposite longitudinal ends thereof.

### BACKGROUND OF THE INVENTION

This invention is an improvement over the disclosure in U.S. Pat. No. 4,880,195, the content of which is to be incorporated herein by reference.

As is illustrated in FIGS. 1 and 2 of this disclosure, a banner support assembly 10 includes a supporting member 11, such as a municipal light pole, a telephone pole or other of a variety of vertically upstanding members. The supporting member 11 can also be a flat planar wall surface. The banner support assembly 10 includes a pair of spaced housing members 12 secured to the supporting member 11 by either flexible banding 13 or bolts. U.S. Pat. No. 4,880,195 discloses one type of housing member that is readily configured for this kind of support.

It is well known in the art that banners 14 supported by and extending between elastically flexible support rods 15 secured to the aforesaid spaced housing members 12 have substantial loads applied thereto in varying wind conditions to cause a reduction of the opposing square footage area of the banner from its original large size SQ1 to a smaller size SQ2. Winds will cause the flexible support rods 14 to flex between the solid line position and the broken line position, for example, the position 15-1 as illustrated in FIG. 2. Yet, these loads can at times still be significant enough to cause the owner of the upstanding member 11 to become concerned about the integrity of the upstanding member and make a requirement that the banner assembly be removed therefrom. Therefore, it is highly desirable for there to be provided to the banner supporting industry a mechanism for preventing substantial loading by winds applied to banners mounted on walls and other variety of upstanding members.

Accordingly, it is an object of this invention to provide a support rod configured for use in a banner support assembly which will facilitate a much better offloading of the wind applied to the banner and yet maintain the banner in a taut vertically upright relation to display the content thereon.

It is a further object of the invention to provide a banner support assembly utilizing the aforesaid support rod.

### SUMMARY OF THE INVENTION

The objects and purposes of the invention are met by providing a rod which has a solid elongate elastically flexible body of a finite length transitioning lengthwise from a first end having a first cross-sectional area to a second end having a second cross-sectional area less than the aforesaid first cross-sectional area. The objects and purposes of the invention are also met by providing a banner support assembly configured to be mounted on a supporting member and utilizing the aforesaid rod construction for holding taut an elongate banner having sleeve-like openings in opposite longitudinal ends thereof.

### BRIEF DESCRIPTION OF THE DRAWINGS

Other objects and purposes of this invention will be apparent to persons acquainted with apparatus of this general type upon reading the following specification and inspecting the accompanying drawings, in which:

FIG. 1 is a side elevational view of a known banner support assembly;

FIG. 2 is a top view of the banner support assembly illustrated in FIG. 1;

FIG. 3 is a top view of a first embodiment of a banner support rod embodying the invention;

FIG. 4 is a view taken along the line IV-IV of FIG. 3;

FIG. 5 is a sectional view taken along the line V-V of FIG. 3;

FIG. 6 is a sectional view taken along the line VI-VI of FIG. 3;

FIG. 7 is a sectional view taken along the line VII-VII of FIG. 3;

FIG. 8 is a top view of a second embodiment of a banner support rod embodying the invention;

FIG. 9 is an end view of FIG. 8 and along the line IX-IX in FIG. 8;

FIG. 10 is a sectional view of the rod illustrated in FIG. 8 and taken along the line X-X of FIG. 8;

FIG. 11 is a sectional view of the rod illustrated in FIG. 8 and taken along the line XI-XI of FIG. 8;

FIG. 12 is a top view of a third embodiment of a banner support rod embodying the invention;

FIG. 13 is an end view of FIG. 12 of the support rod and taken along the line XIII-XIII of FIG. 12;

FIG. 14 is a sectional view of the rod illustrated in FIG. 12 and taken along the line XIV-XIV of FIG. 12;

FIG. 15 is a sectional view of the rod illustrated in FIG. 11 and taken along the line XV-XV of FIG. 12;

FIG. 16 is a top view of a fourth embodiment of a banner support rod embodying the invention;

FIG. 17 is an end view of FIG. 16 and taken along the line XVII-XVII of FIG. 16;

FIG. 18 is a sectional view of the rod illustrated in FIG. 16 and taken along the line XVIII-XVIII of FIG. 16;

FIG. 19 is a sectional view of the rod illustrated in FIG. 16 and taken along the line XIX-XIX of FIG. 16; and

FIG. 20 is a graph facilitating comparison of the wind load characteristics of the prior art banner support assembly employing the known cylindrical support rod illustrated in FIGS. 1 and 2 and banner support assemblies respectively employing the use of the support rods shown in FIGS. 3-19.

### DETAILED DESCRIPTION

Certain terminology will be used in the following description for convenience in reference only and will not be limiting. The words “in” and “out” will refer to directions toward and away from, respectively, the geometric center of the device and designated parts thereof. The words “up” and “down” will indicate directions relative to the horizontal and as depicted in the various figures. Such terminology will include the words above specifically mentioned, derivatives thereof and words of similar import. The direction of the wind is indicated by the arrow X in FIG. 2.

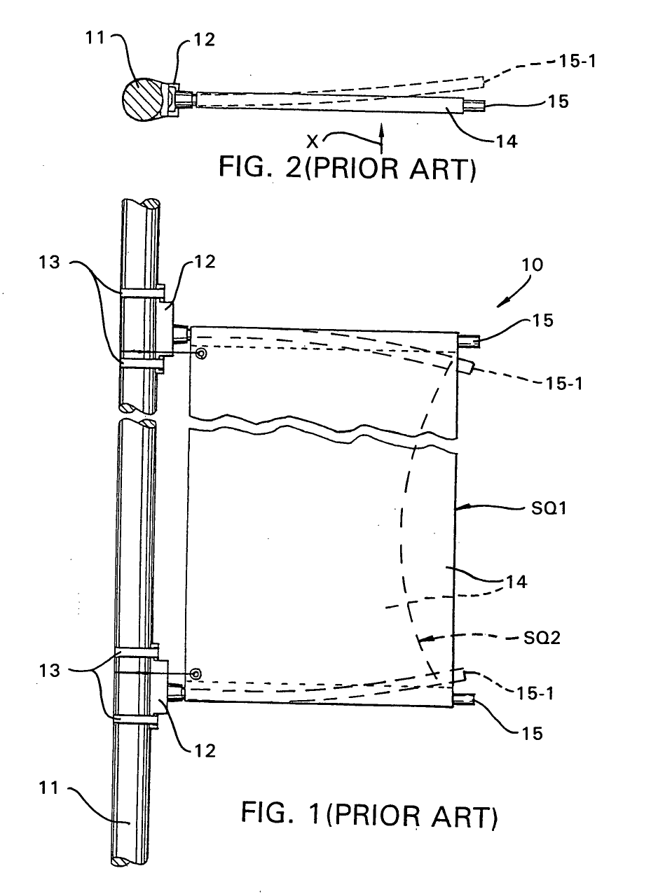

U.S. Pat. No. 4,880,195, the subject matter of which has been incorporated herein by reference, discusses the structure of a prior art banner support assembly 10. This prior art support assembly has been presented herein as FIGS. 1 and 2. As is illustrated in FIGS. 1 and 2, the support rods 15 yield to the position 15-1 upon the application of a wind load in the direction X to the banner stretched between the vertically spaced support rods as schematically indicated in broken lines. However, and since the support rods 15 are of a uniform diameter from the proximal end thereof to the distal end thereof, the ability of the flexible support rods to offload the wind is hampered by the uniform diameter of the support rods.

An ability of the banner support assembly to support a banner and hold it taut between spaced elastically flexible support rods is a very important characteristic which needs to be maintained. Thus, in an effort to enable the elastically flexible support rods to yield easily to wind loads and to effectively offload wind loads of objectionable strength, the elastically flexible support rods deflect while still holding the banner taut at all times. During deflection, we believe that the surface tension in the banner material will remain uniform under all wind conditions. We have discovered a unique way of constructing the support rods and which is the subject matter of this disclosure.

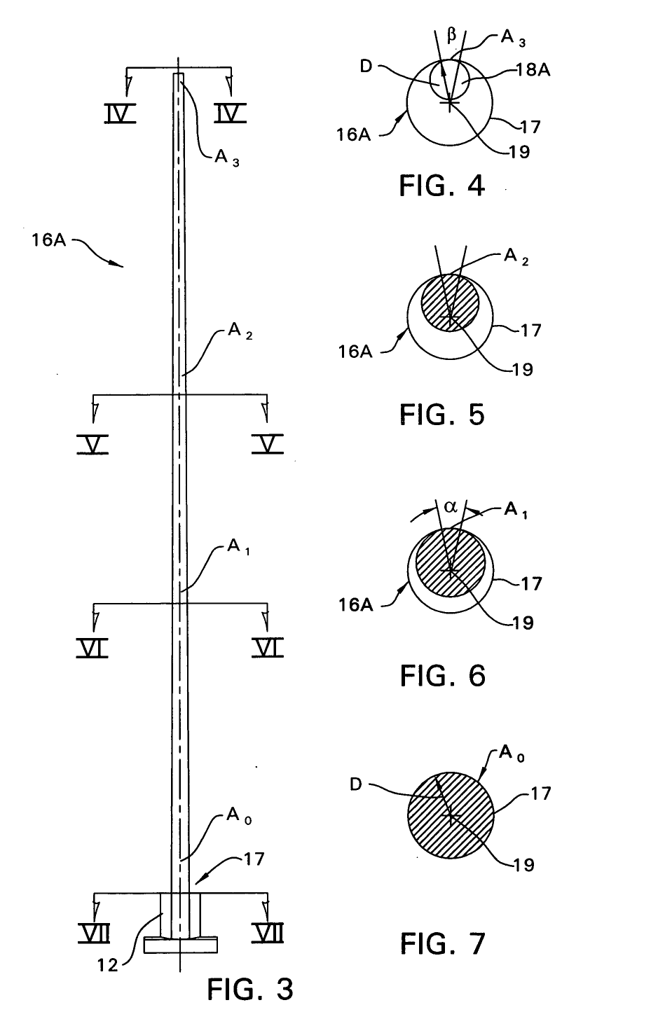

More specifically, FIG. 3 illustrates a typical elongate support rod 16A embodying the invention. There are disclosed herein four different embodiments of the support rod 16A-16D, all of which have the characteristic of being able to offload wind loads much easier than the prior art construction 15 illustrated in FIGS. 1 and 2 and yet retain the ability of maintaining the banner taut in conditions of low wind loads. The four embodiments disclosed herein are of the same 13/16 (0.8125) inches. It is to be recognized that other diameters of support rods can be used and which incorporate the constructions disclosed herein.

Referring now to the inventive support rod 16A (FIG. 3) the proximal end 17 supported by the holder members 12 are in each of the embodiments cylindrical as illustrated in FIG. 7. Each of the support rods transition from the proximal cylindrical end 17 lengthwise to a distal end 18 which has a cross-sectional area less than the cross-sectional area of the proximal end 17. Further, the proximal end 17 as illustrated in FIG. 7 has a central longitudinal axis 19. With this in mind, each of the four embodiments will now be discussed in detail. Since the same reference numerals are used for the various regions of each embodiment of the support rod 16, a different letter suffix has been added to each reference numeral used for the various embodiments to facilitate a distinction between the embodiments.

### Support Rod 16A Embodiment of FIGS. 3-7 (Round Taper)

A view of the distal end 18A of a first embodiment of the support rod 16A is illustrated in FIG. 4. As is clearly evident in FIG. 4, the cross-sectional area of the distal end 18A is less than the cross-sectional area of the proximal end 17 as illustrated in FIG. 7. Furthermore, the distal end 18A is eccentrically oriented relative to a theoretical extension of the central longitudinal axis 19 of the proximal end 17. This feature is particularly important because a common surface area A₀ to A₃ (FIG. 3) exists along one side of the support rod 16A to engage the material of the banner thereat. In this particular embodiment, the surface areas A₀ to A₃ are all arcuate and have a radius of curvature whose center is the aforesaid theoretical extension of the central longitudinal axis 19 of the proximal end 17. As is illustrated in FIG. 7, the semicircular upper half of the proximal end 17 provides a surface area A₀ which contacts the inside surface of the sleeve-like openings provided in the opposite longitudinal ends of the banner as illustrated in FIG. 1. Each corresponding section illustrated in FIGS. 6, 5 all the way through to the distal end view illustrated in FIG. 4 show corresponding decreases in the surface area A₁, A₂ and A₃ which are axially aligned with each other and provide a surface area that is to contact the inside surface of the sleeve-like opening in the elongate banner. The lateral edges of the surface areas are located on radial lines extending outwardly from the central longitudinal axis 19 wherein the angles α and β so defined at the vertex vary along the length of the support rod. In this particular embodiment, the angle α in FIG. 6 is greater than the angle β in FIG. 4. It is also to be noted that each of the arcuate surface areas A₀ to A₃ are each spaced a common distance D away from the theoretical extension of the central longitudinal axis 19.

### Support Rod 16B Embodiment of FIGS. 7-11 (Rectangle)

In this particular embodiment, the proximal end 17 is circular in cross section as represented in FIG. 7. The distal end 18B has a rectangular configuration. The short sides 21 of the rectangle are arcuate and are spaced a distance D radially outwardly from a theoretical extension of the central longitudinal axis 19 of the proximal ends 17. The long straight sides 22 as depicted by the sections appearing in FIGS. 10 and 9 extend in vertical planes. As a result, the radially outwardly facing surface areas B₁, B₂ and B₃ are equal in width so that the angle a in FIG. 11 is equal to the angle β in FIG. 9.

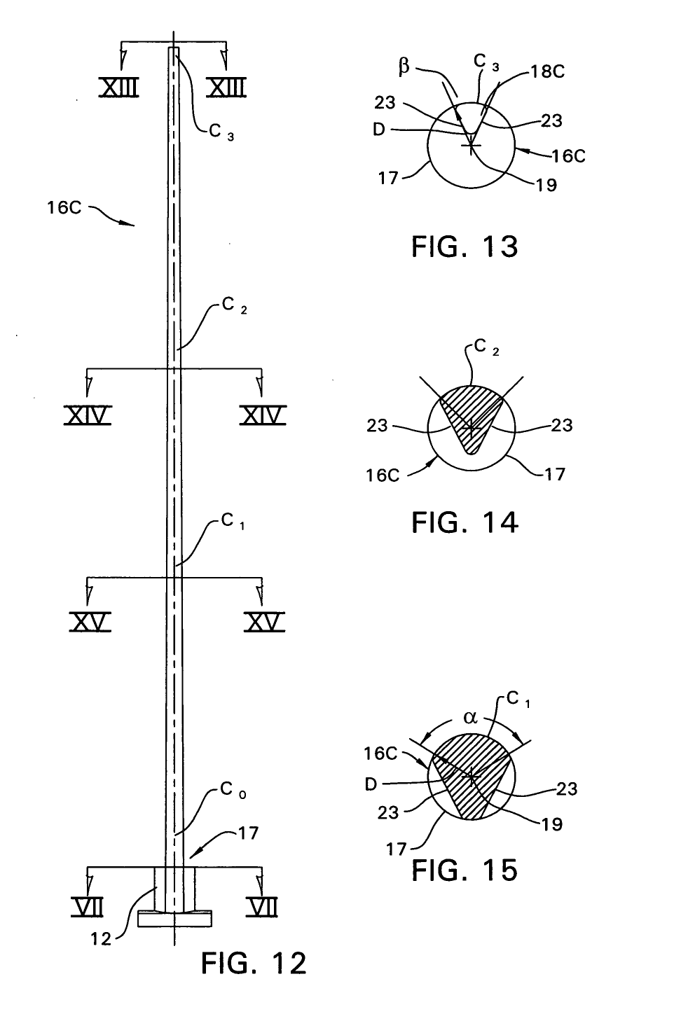

### Support Rod 16C Embodiment of FIGS. 7, 12-15 (V-Taper)

The proximal end of this embodiment corresponds to the view illustrated in FIG. 7, namely, the cross-sectional area of the proximal end 17 is circular. The distal end 18C of the support rods 16C is illustrated in FIG. 11 and has a triangular configuration. The radially outwardly facing surface area C₃ is oriented a distance D from the theoretical extension of the central longitudinal axis 19 of the proximal end 17. The two sides 23 of the triangle illustrated in FIG. 13 lengthen along the length of the support rod 16C toward the proximal end as depicted in FIGS. 14 and 15. The surface areas C₁, C₂ and C₃ decrease along the length from the proximal end toward the distal end as also depicted in FIGS. 15, 14 and 13, respectively. Each of the surface areas C₁, C₂ and C₃ are arcuate and have a radius of curvature corresponding to a radius whose center point is the theoretical extension of the central longitudinal axis 19.

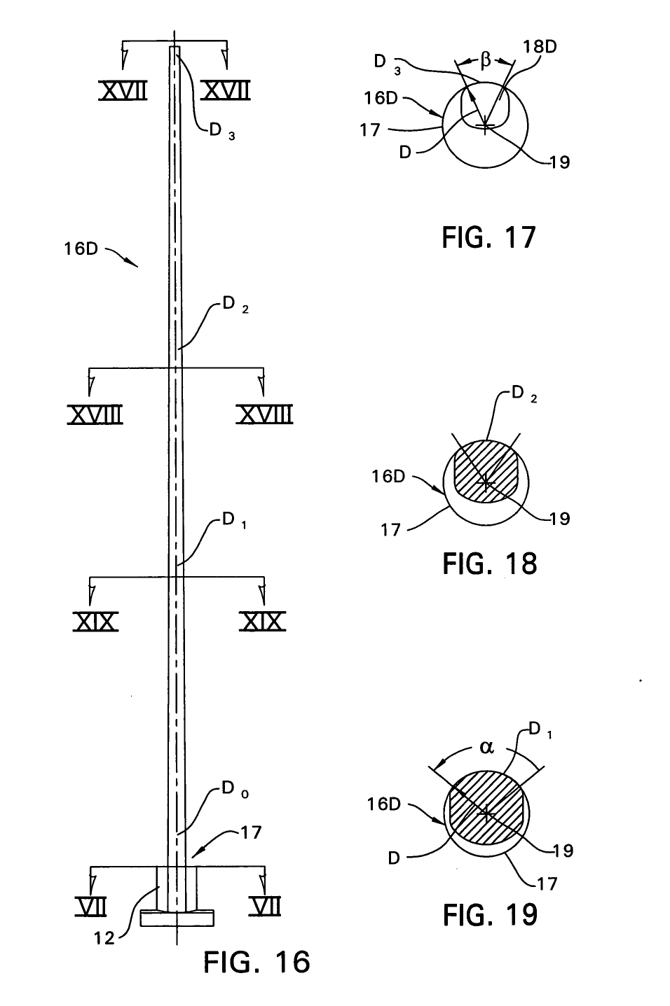

### Support Rod 16D Embodiment of FIGS. 7, 16-19 (Square Taper)

The proximal end for this embodiment corresponds to the construction illustrated in FIG. 7. That is, the cross-sectional area of the proximal end 17 is circular. The distal end 18D of the support rod 16D is generally square with the radially outwardly facing surface area D₃ being arcuate and having a radius of curvature corresponding to the radius D measured from the theoretical extension of the central longitudinal axis 19 of the proximal end 17. Furthermore, the surface areas D₁, D₂ and D₃ on the radially outwardly facing side of the support rod 16D are all axially aligned with one another and decrease in size from the proximal end 17 to the distal end 18D. That is, the width decreases so that the angle α as depicted in FIG. 19 is greater than the angle β illustrated in FIG. 17.

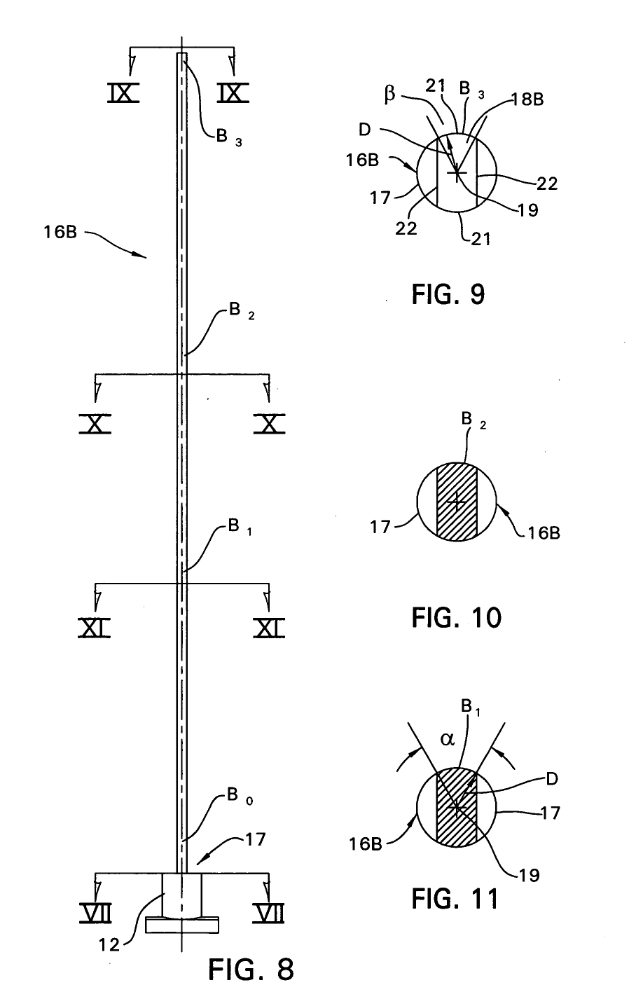

The construction of the support rods 16A to 16D enable the rod to yield left and right of the proximal end 17 (into and out of the page in FIG. 1) while retaining some degree of stiffness in the up and down direction relative to FIG. 7. This is caused by the distal ends of FIGS. 3-6, FIGS. 8-11, FIGS. 12-15 and FIGS. 16-19 embodiments being eccentrically oriented relative to the central longitudinal axis 19. In the embodiment of FIGS. 8-11, this stiffness in the up and down direction is further enhanced by both of the short sides 21 of the rectangle remaining in the same plane as the radially outer surface of the proximal end 17.

In a banner support assembly of the type illustrated in FIG. 2 and utilizing the four support rods 16A, 16B, 16C and 16D disclosed herein, the radially outwardly oriented surface areas A, B, C and D face away from each other in order to enable the material of the sleeve-like openings in the banner to engage them and be held taut thereby.

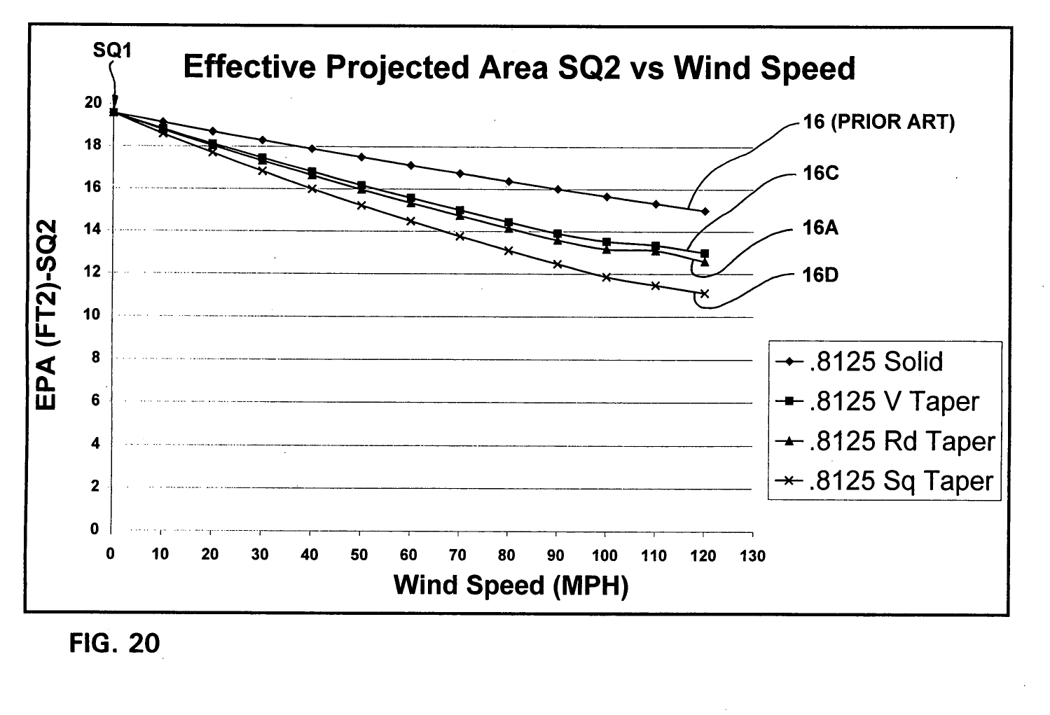

FIG. 20 illustrates a comparison of the reduction in cross-sectional area SQ2 of the banner relative to the cross-sectional area SQ1 of an unloaded banner for the embodiments of rods 16A, 16C and 16D.

The support rods 16 in the four embodiments discussed above are, as noted, fixedly secured to the holder members 12 and are elastically flexible. In addition, they are made of a pultruded fiberglass material, such as a polyester pultruded fiberglass or an epoxy pultruded fiberglass.

Although particular preferred embodiments of the invention have been disclosed in detail for illustrative purposes, it will be recognized that variations or modifications of the disclosed apparatus, including the rearrangement of parts, lie within the scope of the present invention.

1. A rod, comprising:
a solid elongate elastically flexible body having a finite length transitioning lengthwise from a first end having a first cross-sectional area to a second end having a second cross-sectional area less than said first cross-sectional area;
a first radially outwardly facing surface area adjacent said first end spaced radially outwardly a first distance from a central longitudinal axis thereof;
a second radially outwardly facing surface area adjacent said second end spaced radially outwardly said first distance from a theoretical extension of said central longitudinal axis, said second surface area being axially aligned with said first surface area.

2. The rod according to claim 1, wherein said rod includes a third radially outwardly facing surface area spaced radially outwardly said first distance from said theoretical extension of said central axis, said third surface area being axially aligned with said first and second surface areas.

3. The rod according to claim 2, wherein said third surface area is contiguous with said first and second surface areas and has a third cross-sectional area intermediate in size to said first and second cross-sectional areas.

4. The rod according to claim 3, wherein said first, second and third cross-sectional areas are circular.

5. The rod according to claim 3, wherein said first cross-sectional area is circular and said second and third cross-sectional areas form a triangle.

6. The rod according to claim 5, wherein a base of said triangle is said second and third radially outwardly facing surface areas.

7. The rod according to claim 6, wherein said base is an arcuate surface having a radius of curvature whose center is said theoretical extension of said central longitudinal axis.

8. The rod according to claim 3, wherein said first cross-sectional area is circular and said second and third cross-sectional areas form a rectangle.

9. The rod according to claim 8, wherein one side of said rectangle is formed by second and third radially outwardly facing surface areas.

10. The rod according to claim 9, wherein said one side is an arcuate surface having a radius of curvature whose center is said theoretical extension of said central longitudinal axis.

11. The rod according to claim 10, wherein said rectangle is a square.

12. A banner support assembly configured to be mounted on a supporting member for purposes of engaging and holding taut an elongate banner having sleeve-like openings in opposite longitudinal ends thereof, said banner support assembly, comprising:
first and second spaced apart holder members configured for securement to the supporting member; and
a solid elongate elastically flexible support rod fixedly secured at a first end thereof to each of said first and second holder members, each said flexible support rod having a finite length transitioning lengthwise from a first length extending lengthwise a minority of said finite length through to a reduced cross-sectional area distal second end remote from said first end.

13. The banner support assembly according to claim 12, wherein said first segment having a central longitudinal axis, a first radially outwardly facing surface area spaced lengthwise of said first segment being spaced a first distance radially outwardly of a theoretical extension of said central longitudinal axis, a second radially outwardly facing surface area of a majority remainder of said finite length of said flexible support rod being axially aligned with and spaced radially outwardly said first distance from a theoretical extension of said central longitudinal axis.

14. The banner support assembly according to claim 13, wherein said first and second radially outwardly facing surface areas are each an arcuate surface having a radius of curvature whose radial center is said theoretical extension of longitudinal axis.

15. The banner support assembly according to claim 14, wherein said first and second radially outwardly facing surface areas are each an arcuate surface having a radius of curvature whose radial center is said theoretical extension of longitudinal axis; and
wherein a first region of said first arcuate surface area lying between longitudinally extending first laterally spaced boundaries is included within an acute angle α whose vertex is said theoretical extension of said longitudinal axis; and
wherein a second region of a fragment of said second arcuate surface area adjacent said distal second end lying between longitudinally extending second laterally spaced boundaries is included within an acute angle β whose vertex is said theoretical extension of said longitudinal axis.

16. The banner support assembly according to claim 15, wherein said first and second radially outwardly facing surface areas are each an arcuate surface having a radius of curvature whose radial center is said theoretical extension of longitudinal axis; and
wherein said angle α is greater than said angle β.

17. The banner support assembly according to claim 15, wherein said first and second radially outwardly facing surface areas are each an arcuate surface having a radius of curvature whose radial center is said theoretical extension of longitudinal axis; and
wherein said angles α and β are equal.

18. The banner support assembly according to claim 12, wherein said first and second radially outwardly facing surface areas are each an arcuate surface having a radius of curvature whose radial center is said theoretical extension of longitudinal axis; and
wherein said first length has a uniform cross-sectional area.

19. The banner support assembly according to claim 18, wherein said first and second radially outwardly facing surface areas are each an arcuate surface having a radius of curvature whose radial center is said theoretical extension of longitudinal axis; and
wherein a peripheral surface of said first length is radially outwardly spaced said first distance from said central longitudinal axis.

20. The banner support assembly according to claim 12, wherein said first and second radially outwardly facing surface areas are each an arcuate surface having a radius of curvature whose radial center is said theoretical extension of longitudinal axis; and
wherein said first and second holders each have a receptacle therein in each of which is received and secured a respective one of said first lengths.

21. The banner support assembly according to claim 12, wherein said first and second radially outwardly facing surface areas are each an arcuate surface having a radius of curvature whose radial center is said theoretical extension of longitudinal axis; and
wherein an elastically flexible characteristic of said flexible wands cause the surface tension in the banner to remain uniform throughout.

22. The banner support assembly according to claim 12, wherein said first and second radially outwardly facing surface areas are each an arcuate surface having a radius of curvature whose radial center is said theoretical extension of longitudinal axis; and
wherein said first cross-sectional area is circular and said second cross-sectional area is circular.

23. The banner support assembly according to claim 12, wherein said first and second radially outwardly facing surface areas are each an arcuate surface having a radius of curvature whose radial center is said theoretical extension of longitudinal axis; and
wherein said first cross-sectional area is circular and said second cross-sectional area is rectangular.

24. The banner support assembly according to claim 12, wherein said first and second radially outwardly facing surface areas are each an arcuate surface having a radius of curvature whose radial center is said theoretical extension of longitudinal axis; and
wherein said rectangle is a square.

25. The banner support assembly according to claim 12, wherein said first and second radially outwardly facing surface areas are each an arcuate surface having a radius of curvature whose radial center is said theoretical extension of longitudinal axis; and
wherein said first cross-sectional area is circular and said second cross-sectional areas is triangular.

26. The banner support assembly according to claim 12, wherein said first and second radially outwardly facing surface areas are each an arcuate surface having a radius of curvature whose radial center is said theoretical extension of longitudinal axis; and
wherein said first and second radially outwardly facing surface areas on each of said first and second holders face away from each other.

27. The banner support assembly according to claim 12, wherein said first and second radially outwardly facing surface areas are each an arcuate surface having a radius of curvature whose radial center is said theoretical extension of longitudinal axis; and
wherein said flexible wand is made of a pultruded fiberglass material.
